(19) United States
(12) Patent Application Publication
(10) Pub. No.: US 2010/0303420 A1
(43) Pub. Date: Dec. 2, 2010

(54) CONNECTOR ASSEMBLY WITH FLOATABLE FIBER DEVICE

(75) Inventors: HSIEN-CHU LIN, Tu-Cheng (TW); CHI-NAN LIAO, Tu-Cheng (TW); GENN-SHENG LEE, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/791,003

(22) Filed: Jun. 1, 2010

(30) Foreign Application Priority Data
Jun. 1, 2009 (TW) 98118084

(51) Int. Cl. G02B 6/38

(52) U.S. Cl. 385/74

(57) ABSTRACT

A connector assembly (100) includes an insulative housing (1) having a main portion (11) and a tongue portion (12) extending forwardly from the main portion, the main portion (11) defining a depression (111) and the tongue portion (12) defining a cavity (121), and a column (1110) located in the depression; a fiber device (3) including a base (30), two lenses (33) and two fibers (35), the base enclosing the two lenses and the two fibers connecting to the two lenses, respectively; and the two fibers extending into the depression and crossing each other around the column.

### FIELD OF THE INVENTION

The present invention generally relates to a connector assembly, and more particularly to a connector assembly having floatable fiber device.

### DESCRIPTION OF PRIOR ART

At present, Universal Serial BUS (USB) is a widely used input/output interface adapted for many electronic devices, such as personal computer and related peripherals. In 1994, Intel, HP, IBM, NEC etc. together founded USB-IF to define a spec of USB. Nowadays, USB-IF has published several editions for USB, and transmitting rate of USB has becomes higher and higher. As development of electronic industry, higher transmitting rate of USB based connection accessory is needed.

WO Pub. Pat. No. 2008/121731 A1 discloses an optical universal serial bus (OUSB). The OUSB includes a USB connector with a number lenses embedded in the USB connector and further connected with respective fibers for transmitting optical signal. Therefore, the OUSB can transmit signals up to 10 Gbps. However, as the lens are fixed to the USB connector, and they may fail to mate with counterparts if excessive error exits in manufacturing process.

Hence, an improved connector assembly is highly desired to overcome the aforementioned problem.

### SUMMARY OF THE INVENTION

Accordingly, an object of the present invention is to provide a connector assembly with a floatable fiber device.

In order to achieve the object set forth, a connector assembly comprises an insulative housing including a main portion and a tongue portion extending forwardly from the main portion, the main portion defining a depression and the tongue portion defining a cavity, and a column located in the depression; a fiber device including a base, two lenses and two fibers, the base enclosing the two lenses and the two fibers connecting to the two lenses, respectively; and the two fibers extending into the depression and crossing each other around the column.

Other objects, advantages and novel features of the invention will become more apparent from the following detailed description when taken in conjunction with the accompanying drawings.

### BRIEF DESCRIPTION OF THE DRAWINGS

FIG. 1 is an assembled view of the connector assembly;

FIG. 2 is an exploded, perspective view of a connector assembly, with an external cover and a cable thereof omitted;

FIG. 3 is similar to FIG. 2, but viewed from another aspect;

FIG. 4 is a partially assembled view of the connector assembly; and

FIG. 5 is a partial section view of FIG. 1.

### DETAILED DESCRIPTION OF PREFERRED EMBODIMENTS

Reference will now be made in detail to the preferred embodiment of the present invention.

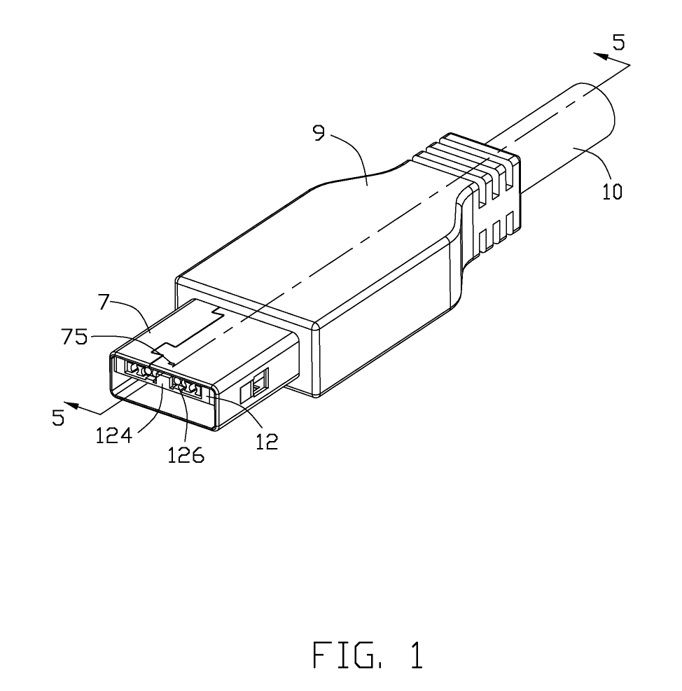

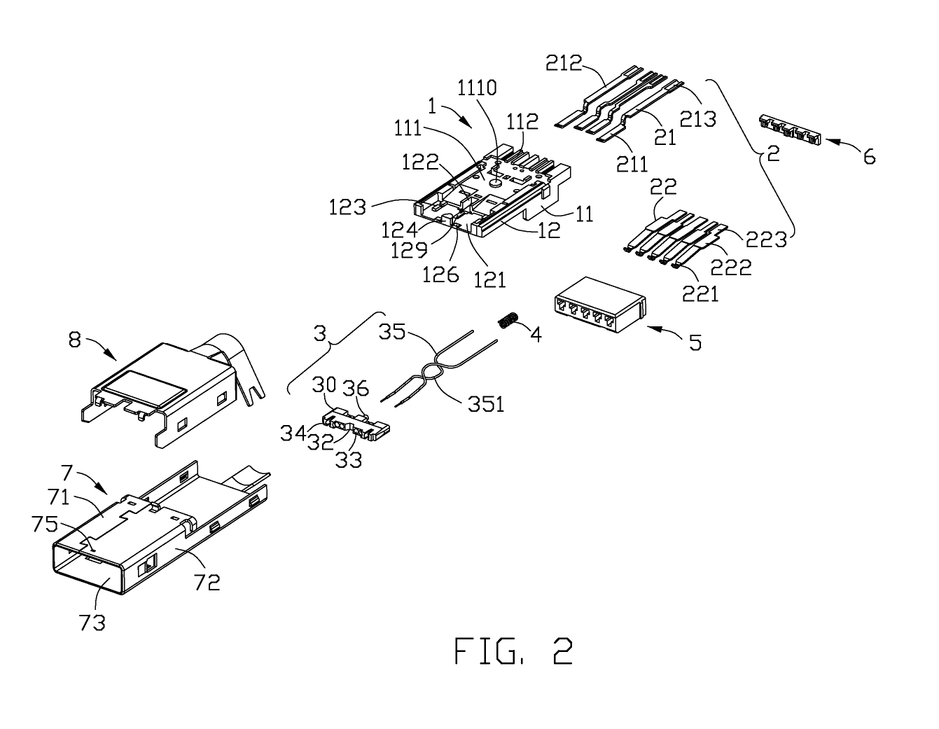

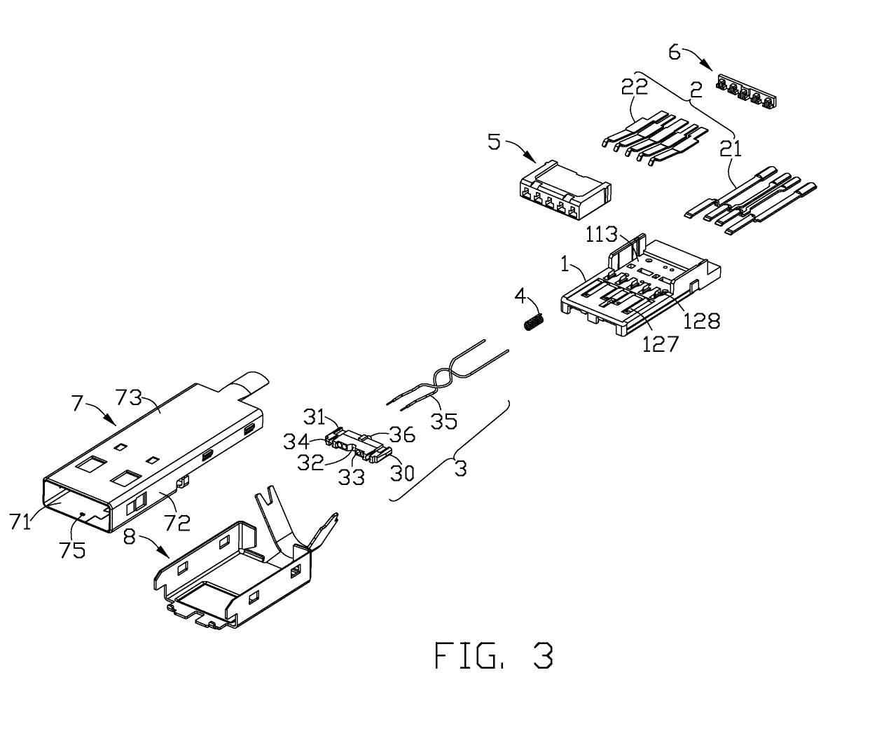

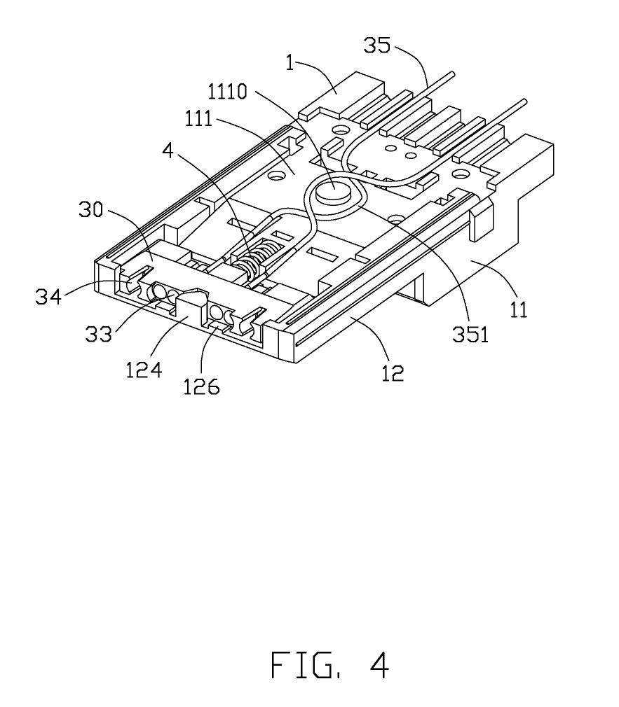

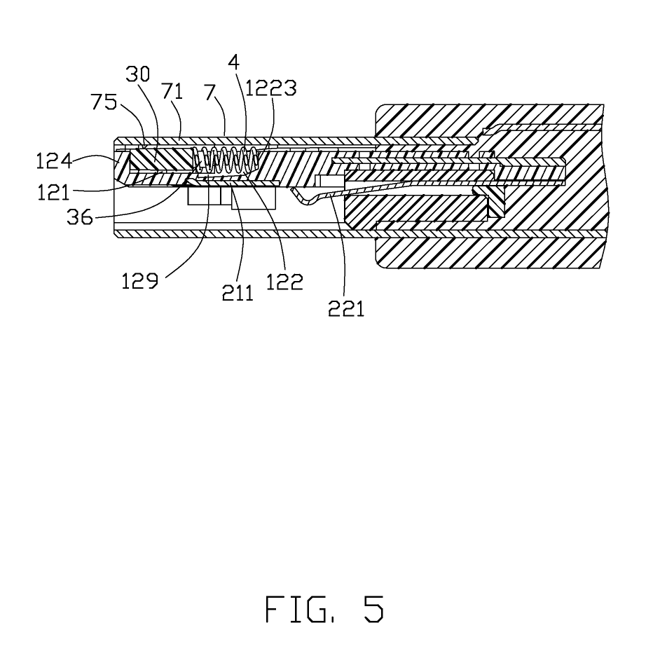

Referring to FIGS. 1-5, a connector assembly 100 in accordance with the present invention comprises an insulative housing 1, a plurality of terminals 2 supported by the insulative housing 1, a fiber device 3 mounted to the insulative housing 1, a spring member 4, a terminal seat 5, an insulator 6, a first metallic cover 7, a second metallic cover 8, an external cover 9 and a hybrid cable 10.

The insulative housing 1 includes a main portion 11 and a tongue portion 12 extending forwardly from the main portion 12. A depression 111 is defined in an upper side of the main portion 11 and a number of grooves 112 are defined in back side of the main portion 11 and communicate with the depression 111. A column 1110 is located in a middle section of the depression 111. A hollow 113 is defined in a lower side of the main portion 11 to receive the terminal seat 5. A cavity 121 is defined in an upper side of the tongue portion 12 and a slot 122 is located behind the cavity 121. The slot 122 communicates with the cavity 121 and the depression 111. The rear portion of the spring member 4 is accommodated in the slot 122. Two guiding ribs 123 are arranged at opposite sides of the cavity 121. A notch 129 is defined in the back side of the cavity 121 and disposed in front of the slot 122. The front portion of the spring member 4 may enter the notch 129, when it joggles along an up-to-down direction. A tapered stopper 124 is formed in a front side of the cavity 121, and two convexes 126 are formed in a front side of the cavity 121 and disposed at opposite sides of the stopper 124. A set of first terminal passages 127 and a set of second terminal passages 128 are defined in a lower side of the tongue portion 12. The first terminal passages 127 are disposed in front of the second terminal passages 128.

The terminals 2 includes a set of first terminals 21 and a second of second terminals 22. Arrangement of the first terminals 21 and the second terminals 22 is accordance with USB 3.0 Spec.

The first terminal 21 has a first mating portion 211, a first tail portion 213 connected to the cable 10, and a first retention portion 212 connecting with the first mating portion 211 and the first tail portion 213. The second terminal 22 has a second mating portion 221, a second tail portion 223 connected to the cable 10, and a second retention portion 222 connecting with the second mating portion 221 and the second tail portion 223. The first mating portions 211 are respectively accommodated in the first terminal passages 127, and the second mating portions 221 are respectively accommodated in the second terminal passages 128. Therefore, the first mating portions 211 and the second mating portions 221 are divided into distinct rows along a front-to-back direction. The first retention portions 212 are embedded in the main portion 11 of the insulative housing 1, and the second retention portions 222 are received in terminal slots (not numbered) in the terminal seat 5 and the insulator 6 is press-fitted with the terminal seat 5 to secure the second terminals 22. The terminal seat 5 is further assembled to the hollow 113 of the insulative housing 1.

The fiber device 3 includes a base 30 with two lenses 33 enclosed in the base 30 and two fibers 35 coupled to the two lenses 33 respectively. Two guiding channels 31 are defined in a bottom side of the base 30 to cooperate with guiding ribs 123. A cutout 32 is defined in a front side of the base 30 to receive stopper 124. Therefore, the base 30 slides in the cavity 121 along the front-to-back direction.

Each of the two fibers 35 extends into the depression 111 via the corresponding groove 112. Part of the fiber 35 located in the depression 111 is bent to form an arched portion 351 which offsets extending direction of rest of the fiber 35 within the depression 111 and rounds/bypasses the column 1110. Therefore, the two fibers 35 cross each other in the depression 111, with the column 1110 encircled by the two arched portions 351 of the two fibers 35. Thus, two fiber intersections respectively disposed in front of and behind the column 11110. By this configuration, the fibers 35 are more flexible to let the fiber device 3 floatable freely. Furthermore, the fibers 35 are avoided breaking off when pulled or compressed. In addition, two aligning holes 34 are defined in the front side of the base 30 to match with aligning posts (not shown) of a complementary connector assembly (not shown), thus the lenses 33 mate with their counterpart accurately. A mounting pole 36 projects backwardly from a back side of the base 30 and inserted into a front portion of the spring member 4. In an alternative embodiment, more lenses or fibers may be adopted.

The fiber device 3 and the terminals 2 are respectively mounted on opposite sides of the insulative housing 1, and the lenses 33 are arranged in front of the terminals 2, therefore this structure may decrease size of the connector assembly 100.

The first metallic shell 7 and the second metallic shell 8 together shield the insulative housing 1. The first metallic shell 7 includes a top side 71 and a bottom side 73 and two lateral sides 72 connecting with the top side 71 and the bottom side 73. A tiny bugle 75 is formed on a front section of a bottom surface of the top side 71.

When the connector assembly 100 mates with the complementary connector assembly (not shown), the base portion 30 is pushed to move backwardly by the complementary connector and biased forwardly by the spring member 4 to adjust relation between the lenses 33 and counterparts. In addition, the front segment of the spring member 4 may gently joggle along up-to-down direction to adjust position of the lenses 33 so as to align the counterparts. When the connector assembly 100 is disconnected with the complementary connector assembly, the base portion 30 moves forwardly, and the stopper 124 cooperates with the cutout 32 to prevent the base sliding outward of the cavity 121, and convexes 126 abut against the front side of the base 30, and the bugle 75 abuts against a top side of the base 30. Thus, the base 30 is restrained in the cavity 121.

The aforementioned embodiment introduces connector assembly with metallic contacts and lenses for electrical and optic signals transmitting. In alternated embodiment, the connector assembly may only include fiber device to transmitting optic signal.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A connector assembly, comprising:
an insulative housing including a main portion and a tongue portion extending forwardly from the main portion, the main portion defining a depression and the tongue portion defining a cavity, and a column located in the depression;
a fiber device including a base, two lenses and two fibers, the base enclosing the two lenses and the two fibers connecting to the two lenses, respectively; and
the two fibers extending into the depression and crossing each other around the column.

2. The connector assembly as recited in claim 1, wherein part of each fiber located in the depression is bent to form an arched portion to bypass the column.

3. The connector assembly as recited in claim 2, wherein there are only two fiber intersections located in the depression.

4. The connector assembly as recited in claim 3, wherein the two fiber intersections are respectively disposed in front of and behind the column.

5. The connector assembly as recited in claim 1, wherein a plurality of terminals are mounted to the insulative housing, and the terminals and the fiber device are disposed at opposite sides of the insulative housing.

6. The connector assembly as recited in claim 5, wherein the terminals include a set of first terminals and a set of second terminals.

7. The connector assembly as recited in claim 6, wherein the set of first terminals have first mating portions and the set of second terminals have second mating portions, and the first mating portions and the second mating portions are mounted onto the tongue portion and spaced apart from each other along a front-to-back direction.

8. The connector assembly as recited in claim 6, wherein the set of first terminals have first retention portions combined with the main portion, and the set of second terminals have second retention portions combined with a terminal seat which is assembled to the main portion.

9. The connector assembly as recited in claim 1, wherein a spring is sandwiched between the base of the fiber device and the insulative housing.

10. The connector assembly as recited in claim 9, wherein a slot is located behind the cavity to receive a rear section of the spring.

11. The connector assembly as recited in claim 9, wherein a mounting pole projects backwardly from a back side of the base and inserts into a front portion of the spring.

12. The connector assembly as recited in claim 1, wherein a stopper is formed in the front portion of cavity and a cutout is defined in the base of the fiber device, and the stopper is accommodated in the cutout.

13. The connector assembly as recited in claim 1, further comprising a metallic shell shielding the insulative housing and the fiber device.

14. An electrical connector assembly comprising:
an insulative housing defining a main body with a cavity facing toward an exterior; and
a fiber device including a base floating within the cavity in a front-to-back direction, and two lenses equipped with two optical fibers side by side arranged in the base and located by opposite two sides of a centerline of the housing; wherein
each of said optical fibers extends rearward from the corresponding lens and across said centerline at least one time so as to enlarge a corresponding movable area thereof for compromising movement thereof during back and forth movement of the fiber device.

15. The electrical connector assembly as claimed in claim 14, wherein the main body is equipped with a column along whose circumference the optical fibers extend.

16. The electrical connector assembly as claimed in claim 15, wherein said column is essentially located at the centerline.

17. An electrical connector assembly comprising:
an insulative housing defining a main body with a cavity facing toward an exterior; and
a fiber device including a base floating within the cavity in a front-to-back direction, and two lenses equipped with two optical fibers side by side arranged in the base; wherein
each of said optical fibers extends rearward from the corresponding lens with a serpentine manner before received in a holding groove so as to enlarge a corresponding movable area thereof between the holding groove and the base for compromising movement thereof during back and forth movement of the fiber device.

18. The electrical connector assembly as claimed in claim 14, wherein the main body is equipped with a column along whose circumference the optical fibers extend.

19. The electrical connector assembly as claimed in claim 15, wherein said column is essentially located at a centerline of the housing by two sides said lenses are located.
